(19) United States
(12) Patent Application Publication
(10) Pub. No.: US 2004/0056852 A1
(43) Pub. Date: Mar. 25, 2004

(54) Source driver for driver-on-panel systems

(76) Inventors: Jun-Ren Shih, Changhua (TW); Huan-Sen Liao, Nantou (TW)

Correspondence Address: BIRCH STEWART KOLASCH & BIRCH, PO BOX 747, FALLS CHURCH, VA, 22040-0747, US

(21) Appl. No.: 10/348,169

(22) Filed: Jan. 22, 2003

(30) Foreign Application Priority Data
Sep. 23, 2002 (TW) 91121727

(51) Int. Cl. G09G 5/00

(52) U.S. Cl. 345/204

(57) ABSTRACT

A source driver for driver-on-panel systems. The source driver includes a digital buffer to receive and schedule externally input digital video data, a set of shift registers to generate corresponding sampling control signals according to the data scheduled, a first set of latches to sample the scheduled data according to the sampling control signals and thus generate corresponding digital video data samples, a second set of latches to hold the samples, a set of level shifts to convert the held samples into high-voltage digital signals, a set of digital-to-analog converters to convert the high-voltage digital signals into analog signals, a set of analog buffers to drive the analog signals to a high-loading display panel, and a set of demultiplexers to output the analog signals at different times to appropriate display positions using time division multiplexing (TDM).

### BACKGROUND OF THE INVENTION

1. Field of the Invention

The invention relates to a source driver for driver-on-panel systems, which uses time division multiplexing (TDM) to reduce the required amount of hardware and relatively reduce areas required for source driver circuits.

2. Description of the Related Art

A source driver can receive quicker digital data sequentially and convert it into slower parallel digital signals. Next, the source driver converts the slower digital signals into analog voltage to drive liquid crystal displays (LCD). A display panel is formed of many pixels. For example, a super video graphics array (SVGA) LCD panel has 800 (horizontal lines)×600 (vertical lines) pixels. In this case, the source driver on the panel requires 800 units of corresponding circuits to properly write all data in the pixels. Each unit has a one-bit shift register, three (R, G, B) n-bit sample latches and hold latches, three digital-to-analog converters (DACs) and three analog buffers. Therefore, such a source driver requires a large area. To reduce required area when designing, for example, the source driver, is very important. This also occurs in increased resolution, particularly for novel source driver-on-panel display systems such as LCOS, LTPS TFT-LCD, OLED and the like.

FIG. 1 is a block diagram of a typical source driver. As shown in FIG. 1, the source driver includes a set of shift registers 11 to generate control signals required by RGB signals; a first set of latches 13 to sample the RGB signals under the control of the control signals; a second set of latches 15 to hold a horizontal line of sampled signals under the control of an externally input signal Hold; a set of digital level shifts 17 to convert the held sampled signals from digital data with low voltage into digital data with high voltage; a set of digital-to-analog converters 19 to convert the digital data with high voltage into analog voltages; a set of analog buffers 21 to receive the analog voltages from the converters 19 and then output to an LCD panel.

FIG. 2 is a timing of FIG. 1. As shown in FIG. 2, when devices 11 receive an externally horizontal address input signal H_serin and accordingly generate control signals to determine when input digital pixels R_data, G_data and B_data can be sampled sequentially and in which direction the sampling starts, such as sampling sequentially to left or to right. This causes the input digital pixel data to be sampled sequentially by corresponding devices 13. Every pixel data respectively corresponds to a source line and K sets of data have to be sampled completely within a Horizontal Total Time (including Synchronization Sync, Back Porch BP, Active Video AV and Front Porch FP). When signal Hold is input to devices 15, devices 15 will release the sampled data to next devices 17 in parallel in order to convert the sampled data into digital signals with high voltage. Signal Hold must be located in blanking time. The blanking time represents the total time of signals FP+Sync+BP, i.e., the interval time between two data transmissions (signal AV). Digital signals with high voltage generated by devices 17 are converted by devices 19 into corresponding analog voltages and then output by devices 21 to drive the LCD panel. Every pixel requires a driving unit including the n-bit (i.e., the bit number of R, G, B input signals) devices 13, 15, 17 and the one-bit devices 11, 19, 21 that all correspond to the same RGB channel (Channel_RGB(1). . . or Channel_RGB(K). Thus, every horizontal line requires K driving units Channel_RGB(1)-Channel_RGB(K). Such a source driver configuration results in a large increase in overall size. Once resolution is increased (K increases), the bottleneck in design will occur or fabrication cost increases.

FIG. 3 is a block diagram of another typical source driver, as disclosed in U.S. Pat. No. 6,097,362. The circuit includes a set of shift registers 31 to generate control signals LP1-LP80 with respect to shift registers for determining when input digital pixels can be sampled sequentially and in which direction the sampling starts, such as sampling sequentially to left or to right; a first set of latches 33 to sample R, G, and B signals under the control of the control signals LP1-LP80 and accordingly generate 7-bit samples for output; a set of bit converters 35 to convert every 7-bit sample into a respective 13-bit sample; a multiple-to-one multiplexer (MUX) 37 to convert 13-bit samples from devices 35 into a sequential output in order to send a set of digital pixel data with red, green, blue colors at different times; a 128-ladder 47 to provide a 128 level-to-analog voltage map; a set of digital-to-analog converters 39 to convert the sequential output into corresponding analog voltages of red, green, blue according to the map; a one-to-multiple demultiplexer (DEMUX) 41 to output the analog voltage generated by the device 39 at different times under the control of the control signals LP1-LP80; a set of analog S/H circuits 43, 45 to sequentially receive analog voltages from the device 41 and output the received analog voltages to an LCD panel.

FIG. 4 is a timing of control signals of the shift registers in FIG. 3. As shown in FIG. 4, when I/O control signal equivalent to signal H_serin in FIG. 1 goes to logic “1”, shift registers shift1-shift80 generate a respective control signal LP1-LP80 to determine sequential sampling direction and time. For example, when I/O control signal shown in FIG. 4 goes from 0 to 1, input signals R, G, B are sampled sequentially starting from left to right. As such, under the control of the control signals LP1-LP80, device 33 samples input R, G, B signals sequentially starting from left to right and thus respectively generates a 7-bit digital sample with respect to channels CH1R-CH240B for the input R, G, B signals. Next, device 35 is driven by the control signals LP1-LP80 to convert every 7-bit sample to a 13-bit digital sample and device 37 in turn selects one of the 13-bit digital sample including R, G, B signals. Next, device 39 converts every 13-bit sample to a respective analog voltage signal with reference to the analog voltage signals transferred by device 47 (128-ladder) and output the converted analog signals to device 41 for demultiplexing in order to recover the parallel input form to channels CH1R-CH240B. After recovery, every analog voltage signal in the channels is temporarily stored in device 43 until I/O control signal becomes logic 1. When I/O control signal is logic 1, the stored signals are output to device 45 for display on the LCD panel.

The above device can save the number of DACs from 240 to 3 but the number of shift registers, first and second latches, and analog buffers are not reduced. Such a configuration may not be laid out on a high-resolution display panel due to the large area requirement. For example, LCOS source driver used in existing novel projectors has a very small pixel pitch, e.g., a pixel pitch 9.5 microns for an HDTV or the like. Such a small pixel pitch limits the layout area available for the source driver and even smaller to about 9.5×N×2 microns in width (N=the number of TDM used, 2=dual source driver) for every channel. As such, layout area available for source drivers is an important point in design of a display chip.

### SUMMARY OF THE INVENTION

An object of the present invention is to provide a source driver for driver-on-panel systems requiring only a small area to lay out in pixel pitch and is thus integrated into an LCOS panel.

Another object of the present invention is to provide a source driver for driver-on-panel systems, which uses only the Time-Division Multiplexing (TDM) to reduce the source driver requirement from K to K/N copies and thus relatively reduce the required layout area, driving power and fabricated cost.

Accordingly, the present invention provides a source driver for driver-on-panel systems, including a digital buffer to receive and schedule externally input digital video data, a set of shift registers to generate corresponding sampling control signals according to the data scheduled, a first set of latches to sample the scheduled data according to the sampling control signals and thus generate corresponding digital video data samples, a second set of latches to hold the samples, a set of level shifts to convert the held samples into high-voltage digital signals, a set of digital-to-analog converters to convert the high-voltage digital signals into analog signals, a set of analog buffers to drive the analog signals to a high-loading display panel, and a set of demultiplexers to output the analog signals at different times to appropriate display positions using time division multiplexing (TDM).

### DESCRIPTION OF THE DRAWINGS

For a better understanding of the present invention, reference is made to a detailed description to be read in conjunction with the accompanying drawings, in which:

FIG. 1 is a block diagram of a typical source driver circuit;

FIG. 2 is a timing of FIG. 1;

FIG. 3 is a block diagram of another typical source driver circuit;

FIG. 4 is a control signal timing of the shift register in FIG. 3;

FIG. 5 is a block diagram of a source driver circuit according to the present invention;

FIG. 6 is an example of a demultiplexer circuit in FIG. 5 according to the present invention; and

FIG. 7 is a timing of the operation of FIGS. 5 and 6 according to the present invention.

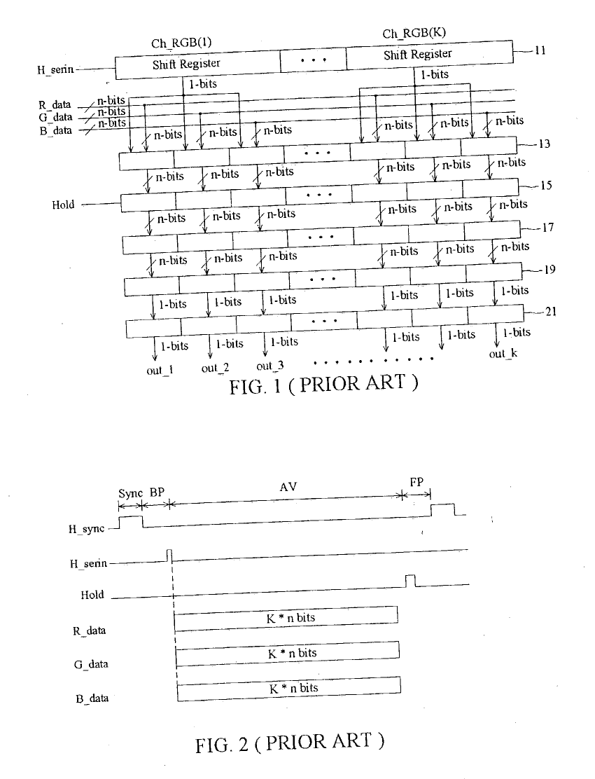

### DETAILED DESCRIPTION OF THE INVENTION

Similar elements denote the same numbers throughout the description and drawings.

FIG. 5 is a block diagram of a source driver circuit according to the present invention. In FIG. 5, the circuit includes a digital buffer 65, a set of shift registers 51, a first set of latches 53, a second set of latches 55, a set of level shifts 57, a set of digital-to-analog converters 59, a set of analog buffers 61, and a set of demultiplexers 63. The digital buffer 65 receives and stores three packets of n-bit digital video data R_data, G_data and B_data. The shift registers 51 output control signals required by the three packets to be sampled according to an externally initial signal H_serin. The first latches 53 sample the three packets after the control signals are received. The second latches 55 hold the samplings of the three data. The level shifts 57 convert the held samplings into high-voltage digital signals, for example, converting a digital signal in a computer from 5V to 12V. The DACs 59 convert the high-voltage digital signals into corresponding analog signals. The analog buffers 61 temporarily store the analog signals. The demultiplexers perform the TDM operation.

As shown in FIG. 5, when operating with the source driver, sequential pixel data is re-arranged by the device 65. As a horizontal (scan) line has K pixels and corresponding source drivers have M circuit units, the K pixels are first divided into N sequences such that each includes M pixel data, i.e. K=N×M. Every M pixel data is processed as below. The devices 51 generate control signals to determine when and in which direction the data is sequentially sampled. Thus, the devices 53 sample the sequential data by means of one pixel data to one channel (one circuit unit) and every pixel data includes R, G, B information, respectively sampled by one device 53 such that the resulting samples are 3×M samples. The sampling must be completed within 1/N horizontal time. When devices 55 receive an external hold signal Hold, the data stored in devices 55 is released to next devices 57 for conversion into high-voltage digital signals. High-voltage digital signals generated by devices 57 generate corresponding analog voltages via devices 59. Analog voltages generated by devices 59 are output to devices 63 through devices 61 such that devices 63 will arrange analog voltages of M channels to corresponding source lines. Thus, a horizontal line of K data is sent to the LCD panel N times in an expression of M data at a time.

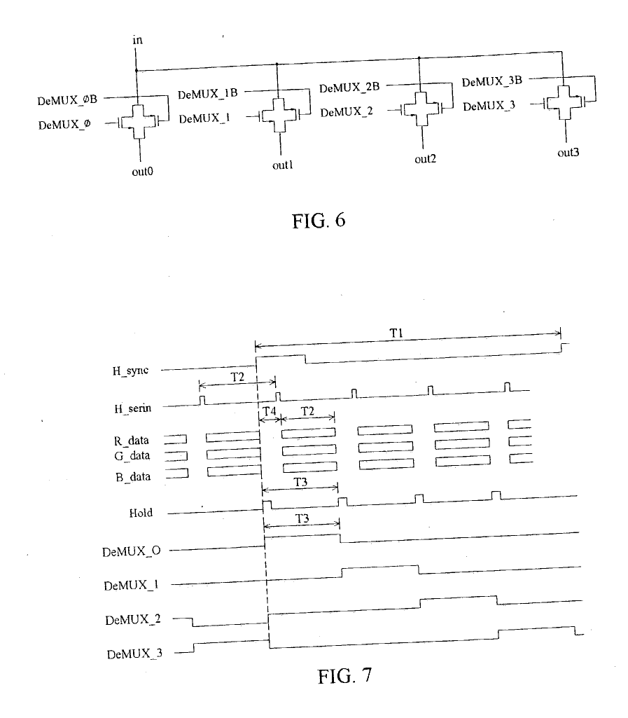

FIG. 6 is an example of a unit of the demultiplexer circuit of FIG. 5. As shown in FIG. 6, the circuit is a one-to-multiple selector with one input in and N outputs out0-out3, here, N=4. The input in is connected to one of out0, out1, out2 or out3, depending on the time selected by the selector, to receive and output data on the respective source line. As shown, the selector is formed by CMOSs controlled by four pairs of complementary signals (DeMUX_0B, DeMUX_0), (DeMUX_1B, DeMUX_0), (DeMUX_2B, DeMUX_2), and (DeMUX_3B, DeMUX_3). Devices 63 must have a selective source sequence coincident with an output source sequence by devices 61. For example, the first sequence of M pixel data is output respectively to source lines 1, N+1, 2N+1 . . . ; the second sequence of M pixel data is output respectively to source lines 2, N+2, 2N+2, . . . ; and the N sequence of M pixel data is output respectively to source lines N, N+N, 2N+N . . . , such that a horizontal line of data is complete to the panel by outputting N times.

In order to achieve the output sequence of source lines, devices 65 will re-arrange received signals R_data, G_data and B_data for output to meet the source line output requirement.

FIG. 7 is a timing of the operation of FIGS. 5 and 6 according to the present invention. As shown in FIG. 7, in a Horizontal Total Time H_sync, the present invention first re-arranges the input data R_data, G_data and B_data through devices 65 for every N parts as a unit (in this case, N=4 as shown in FIG. 6), and then provides the N-part data to source drivers with built-in N-part control signals H_serin, Hold, such that the demultiplexers with N-part outputs DEMUX_0, DEMUX_1, DEMUX_2 and DEMUX_3 are sequentially operated to output the re-arranged data N times, wherein T1=a Horizontal Total Time, T2=a Horizontal Address Time/N, T3=T1/N and T4=Blanking Time/N.

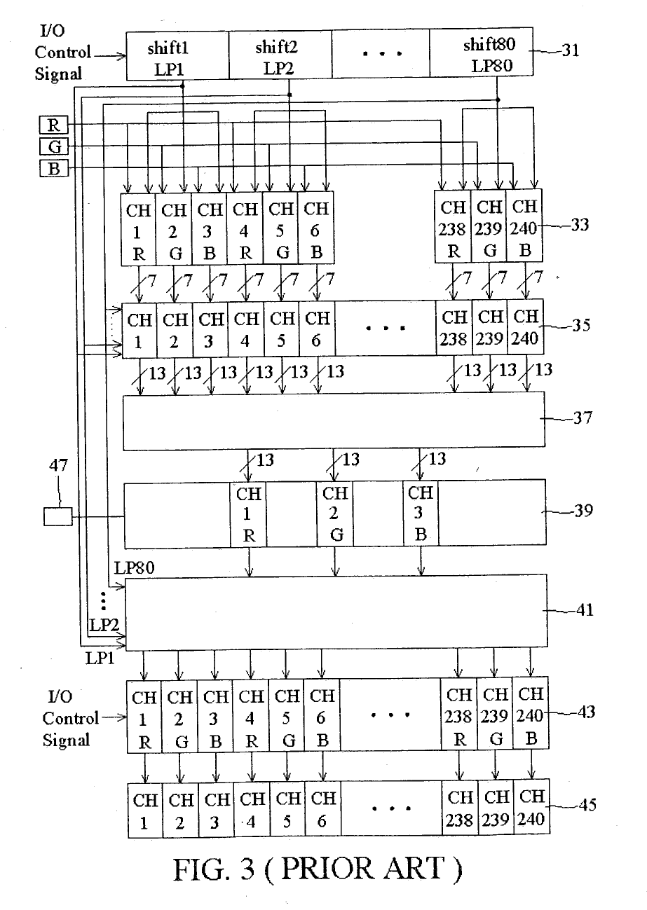

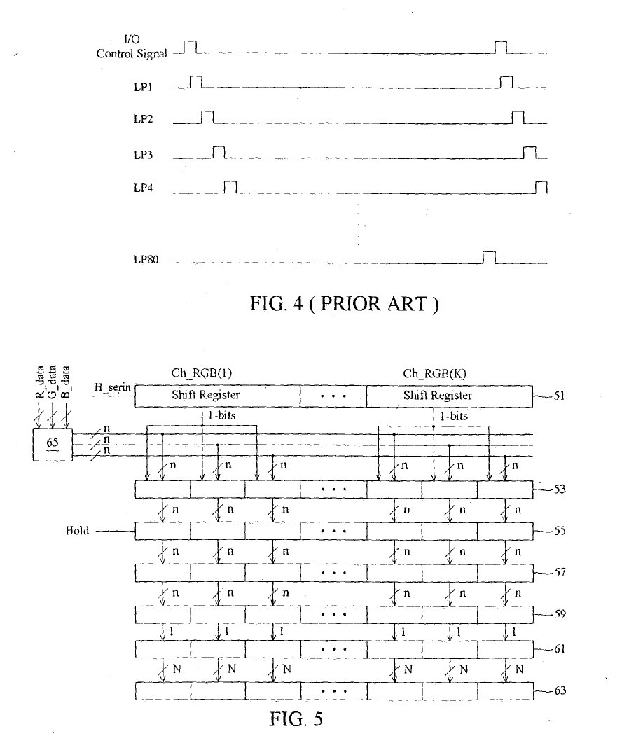

As cited, the present invention can save hardware requirement from K source drivers for K channels down to 1/N source drivers for M channels using time division multiplexing (TDM). Accordingly, area required for the inventive source drivers is effective down to 1/N. N is decreased as the resolution of an LCD panel is increased so that pixel voltages on the panel can gain sufficient time to be charged to saturation. For example, source drivers can have a small area to lay out source drivers due to the pixel pitch limit on an LCD on Silicon (LCOS), whereas with the present invention, the same layout area can gain a higher resolution than in the prior art. Additionally, if the resolution is as high as, for example, 1600×1200 pixels or so (i.e., for UXGA level products), the highest N value required for the present invention is between 4-8. As a common TFT-LCD uses the inventive configuration of source drivers, such devices 33, 35, 43 and 45 are eliminated when compared to the patent U.S. Pat. No. 6,097,362, which leads to a smaller area for source drivers. For example, when 80 RGB channels are evaluated, source drivers in a conventional design manner (FIG. 1) require a set of 80-level shift register, 80-level first latch and 80-level second latch, and a set of 240 DACs; source drivers in U.S. Pat. No. 6,097,362 (FIG. 3) require a set of 80-level shift register, 80-level first latch and 80-level second latch, and a set of 3 DACs; and source drivers in the present invention for N=80 require a set of one-level shift register, one-level first latch and one-level second latch, and a set of 3 DACs. As cited, the layout area required for the inventive source drivers is reduced to ½ of the conventional manner or the U.S. Pat. No. 6,097,362, or even more.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A source driver for driver-on-panel systems with high-resolution display panels, comprising:
a digital buffer to receive and schedule externally input digital video data;
a set of shift registers to generate sampling control signals corresponding to the data scheduled;
a first set of latches to sample the scheduled data according to the sampling control signals and thus generate corresponding digital video data samples;
a second set of latches to hold the samples;
a set of level shifts to convert the held samples into high-voltage digital signals;
a set of digital-to-analog converters to convert the high-voltage digital signals into analog signals;
a set of analog buffers to drive the analog signals to a high-loading display panel; and
a set of demultiplexers to output the analog signals at different times to appropriate display positions using time division multiplexing (TDM).

2. The source driver of claim 1, wherein the high-loading display panel is a high-resolution display panel such as a Thin Film Transistor-Liquid Crystal Display (TFT-LCD), Liquid Crystal Display on Silicon (LCOS) or an equivalent display panel.

3. The source driver of claim 1, wherein the externally input digital video data comprises RGB primary color signals.

4. The source driver of claim 1, wherein the digital buffer changes scheduling of the video data with the high-resolution display panels used.

5. The source driver of claim 1, wherein the demultiplexer is a one-to-multiple selector with one input and multiple outputs, to connect the one input to one of the multiple outputs at the time selected by the TDM.

6. The source driver of claim 5, wherein the selector has a sequence of receiving and outputting external source line signals coincident to the analog signals driven by the respective analog buffer, and the sequence is scheduled by the digital buffer.
